(19) United States
(12) Patent Application Publication
(10) Pub. No.: US 2002/0005095 A1
(43) Pub. Date: Jan. 17, 2002

(54) TOOL BIT DRIVE SLEEVE AND HAND TOOL

(76) Inventors: WAYNE ANDERSON, NORTHPORT, NY (US); PAOLO CASSUTTI, NORTHPORT, NY (US)

Correspondence Address: LACKENBACH SIEGEL MARZULLO, ARONSON & GREENSPAN PC, PENTHOUSE SUITE, ONE CHASE ROAD, SCARSDALE, NY, 10583

(21) Appl. No.: 09/309,673

(22) Filed: May 11, 1999

Related U.S. Application Data
(63) Continuation-in-part of application No. 09/237,557, filed on Jan. 26, 1999, now Pat. No. 6,257,106.
Application No. 09/237,557 is a continuation-in-part of application No. 08/904,606, filed on Aug. 1, 1997, now Pat. No. 6,010,361.
Application No. 08/904,606 is a continuation-in-part of application No. 08/451,398, filed on May 26, 1995, now Pat. No. 5,711,194.
Application No. 08/451,398 is a continuation-in-part of application No. 08/620,471, filed on Mar. 22, 1996, now abandoned.

(51) Int. Cl. B25B 23/00

(52) U.S. Cl. 81/440

(57) ABSTRACT

A tool bit drive sleeve for a hand tool has a central axis and is formed with an integral flange with means for rotating the sleeve from an inoperable position within or adjacent the handle to an operable position disposed about 180° from the inoperable position, and wherein the axis of rotation is spaced from the sleeve central axis, so that the sleeve is disposed adjacent the side edge of the handle to be readily grasped in the inoperable position for rotation to the operable position whereat the sleeve and tool bit drive are preferably centrally disposed to the handle.

### PRIOR RELATED APPLICATIONS

This application is a continuation-in-part application of U.S. Ser. No. 09/237,557, filed Jan. 26, 1999, which is a continuation-in-part of 08/904,606, filed Aug. 1, 1997, which is a continuation-in-part of 08/451,398, filed May 26, 1995, now U.S. Pat. No. 5,71,194 and a continuation-in-part application of U.S. Ser. No. 08/620,471, filed Mar. 22, 1996, now abandoned.

### BACKGROUND OF THE INVENTION

1. Field of the Invention

This invention relates to a tool bit drive sleeve and a hand tool incorporating such sleeve. The hand tool is generally of the multiple function hand tool.

2. Background and Discussion of the Prior Art

The prior art was directed to central alignment of the screwdriver bit with the axis of rotation about which the screwdriver bit was rotated to an operable position. Garrett, U.S. Pat. No. 3,364,508, granted Jan. 23, 1968, disclosed a bladed tool for golfers in which a single screwdriver bit was formed at the remote end of one of the blades, with the central axis of screwdriver bit intersecting the rotation axis of the blade. Kikel, U.S. Pat. No. 4,848,197, granted Jul. 18, 1985, continued the prior art direction, wherein central axis of the screwdriver bits intersected the rotation axis of the sleeve.

### SUMMARY OF THE INVENTION

This invention is a further improvement in tool bit drive sleeve construction disclosed in U.S. Pat. No. 5,711,194, granted Jan. 27, 1998, and that disclosure is incorporated herein by reference thereto.

The present invention, in one aspect, is a hand tool sleeve for holding tool bit drives at one end and is formed with a flange having means for rotating the sleeve from an inoperable position adjacent the hand tool to an operable position disposed away from the handle, and wherein the sleeve has a central axis and the means for rotating the sleeve has a rotation axis, and wherein the rotation axis and sleeve axis are spaced so as not to intersect. The spaced axis construction permits more advantageous disposition of the sleeve in the operable and inoperable positions. This is particularly so where the sleeve is centrally disposed to the hand tool in the operable position for more effective driver use, and where the sleeve is non-centrally disposed to the hand tool in the inoperable position for ready grasping of the sleeve for rotation away from the handle to the operable position.

### BRIEF DESCRIPTION OF THE DRAWINGS

FIG. 1 is a slide elevational view of the hand tool with sleeve of the present invention in the about 180° operable position;

FIG. 2 is a perspective view of the hand tool of FIG. 1 shown in use;

FIG. 3 is a side elevational view as in FIG. 1, but showing the sleeve in phantom views in, respectively, the about 90° operable position and in the inoperable position;

FIG. 4 is a side elevational view as in FIG. 1, but with the immediate handle side plate removed for an exposed view;

FIG. 5 is an enlarged fragmentary bottom perspective partially exposed view of the sleeve rotation mechanism of the hand tool of FIG. 1; and

FIG. 6 is a view as in FIG. 5, but showing use of the sleeve rotation mechanism.

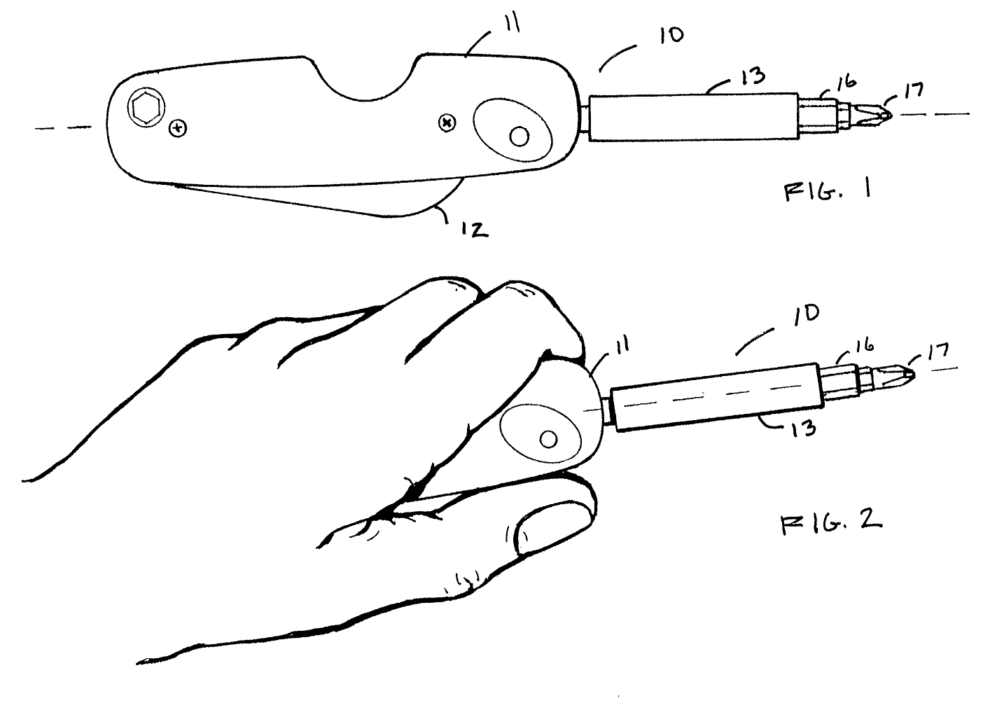

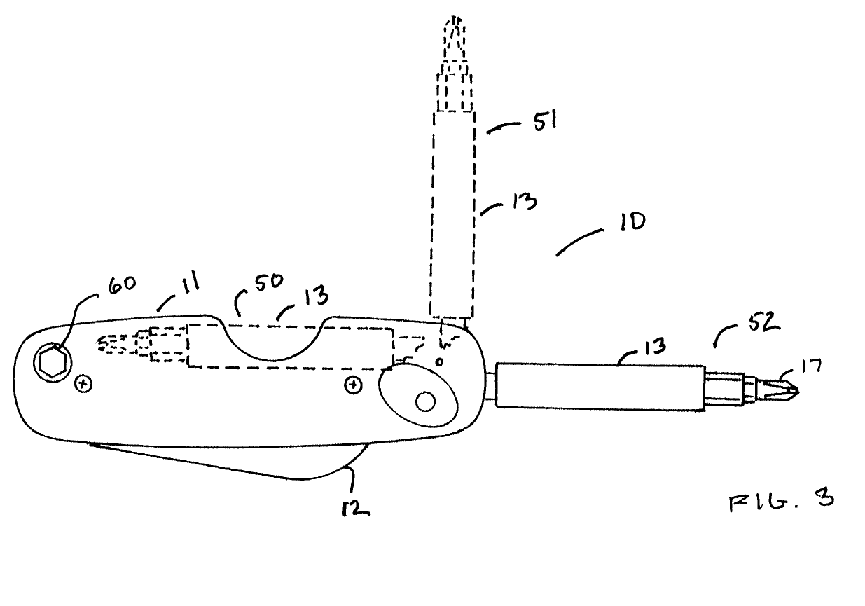

### DESCRIPTION OF THE PREFERRED EMBODIMENT

Referring to the FIGS., there is shown hand tool 10 of the present invention. Hand tool 10 generally, has an elongated handle 11, a knife blade A, which is removably disposed in the handle in the well known manner, and sleeve 13 of the present invention.

Sleeve 13 is formed of two principal portions; the elongated cylindrical hollow sleeve 14 and the integral flange 15. Sleeve 14 has a hexagonal inner surface (not shown) to receive hexagonal inner sleeve 16 and tool drive bit 17 (typical). The tool drive bit drive arrangement and construction is shown in U.S. Pat. No. 5,711,194. Sleeve 14 has a central axis 30 for purposes hereinafter appearing.

Flange 15 is of a generally planar construction and is formed with a connection portion 18 integral to the circular bottom 19 of sleeve 14 and a generally flat transversely disposed plate 20. Plate 20 is formed with a pivot hole 21 for slidably rotatable mounting on pivot rod 22 and having pivot rotation axis 25, for purposes hereinafter appearing.

As best shown in FIG. 4, plate 20 has a first convex portion 26 a contiguous first concave lock portion 27, a contiguous second convex portion 28 a contiguous second concave lock portion 29 a contiguous third convex portion 31, a contiguous third concave lock portion 3, a contiguous fourth convex portion 33 which in turn is integral to connecting portion 18.

Handle 11 is formed with elongated parallel side plates 34 and 35, with plate 35 removed in FIG. 4 for exposed view of the operation of sleeve 14 and particularly flange 15. Plates 34 and 35 are integrally co-joined by centrally disposed screws or like elements 38 and 39. Screws 38 and 39 are disposed along handle central axis 61 (FIG. 4). Handle central axis 61 and sleeve central axis 30 are co-incident where sleeve 14 is disposed in the operable position 5, as shown in FIG. 4.

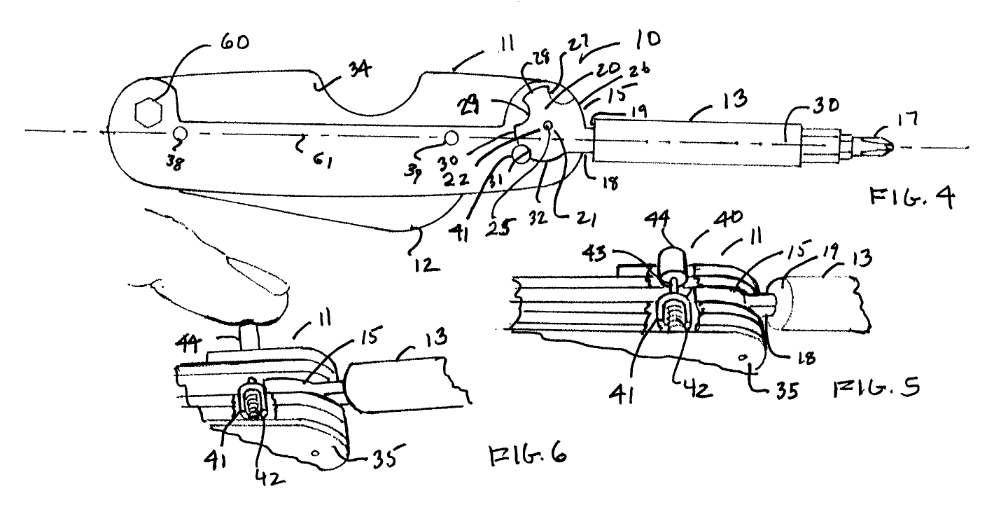

A spring actuated stop pin assembly 40 is mounted to handle 11. Assembly 40 is formed with a hollow stop pin 41 with internal spring 4. and integral rod extension portion 43 with finger depression actuation piece 44 operably mounted in outer plate lock finger recess 47. Pin 41 is circumferentially sized to be alternatively received in first, second and third concave lock portions 27, 29 and 32 of sleeve plate 20. That is, with finger depression of actuation piece 44, pin 41 is moved transversely free of plate 20 so that flange 15 is free to rotate about rotation axis 25 as best shown in FIGS. 5 and 6.

In the aforesaid manner of construction, the user depresses piece 44 to free flange 15 for rotation to three alternative lock positions, namely an inoperable position 50 within or adjacent the handle 11, a first operable position 51 disposed about 90° from the inoperable position 50 and a second operable position, namely position 52 which is disposed about 180° from inoperable position 50.

It is an important aspect of the present invention that the sleeve central axis 30 and the flange rotation axis 25 are spaced and do not intersect. The spacing from sleeve central axis 30 to flange rotation axis 25 is preferably about one-half the outer diameter (or the outer radius) of the sleeve 14 cylinder surface. In this manner of construction, the sleeve with the tool bit drive when in the second operable position are centrally disposed to the mass of the handle 17 (FIG. 4) for effective application of the drive torque forces (FIG. 2). Further, in this manner of construction, the sleeve 13 with the tool bit drive is non-centrally disposed in handle 11 in the inoperable position 50 adjacent the elongated side edges of the handle 11 to permit ready grasping of the sleeve for rotation of the sleeve to the selected operable positions 51 and 52.

Handle 11 is also formed with a hexagonal cross hole 60 for selectively recessing hexagonal tool bit drive, as shown and described in U.S. Pat. No. 5,711,194.

Thus, since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A hand tool comprising:
handle means;
sleeve means for operably holding at least one tool bit drive means;
means for rotatably connecting said sleeve means to said handle means for rotation from an inoperable position to an operable position;
said sleeve means comprising a central axis and said means for rotatably connecting said sleeve means comprising a rotation axis and wherein the rotation axis is spaced from the central axis.

2. The hand tool of claim 1, said handle means comprising a central axis and wherein the handle means central axis and sleeve means central axis are about coincident in the operable position.

3. The hand tool of claim 1, said handle means being elongated and comprising oppositely disposed elongated edges, and said handle means central axis being about centrally disposed between said edges, and said rotation axis being disposed more adjacent one edge than the other.

4. The hand tool of claim 1, said means for rotatably connecting the sleeve means comprising means for rotating the sleeve to a first operable position and a second operable position.

5. The hand tool of claim 4, said handle means comprising a central axis, and said first operable position being disposed about 90° from the handle means central axis and the second operable position being disposed about 180° from the handle means central axis.

6. The hand tool of claim 5, said means for rotating said sleeve means and said handle means having cooperative means for selectively locking said sleeve means in said first position and in said second position.

7. The hand tool of claim 1, said means for rotating said sleeve means and said handle means having cooperative means for selectively locking said sleeve means in said operable position.

8. The hand tool of claim 7, said cooperative means comprising spring means and means for actuating said spring means to releasably unlock said means for rotating said sleeve means.

9. The hand tool of claim 1, further comprising knife blade means and means for rotatably connecting said knife blade means to said handle means for rotation from an inoperable position to an operable position.

10. The hand tool of claim 9, said handle means being formed with non-circular hole means for operably receiving the tool bit drive means.

11. The hand tool of claim 10, said handle means having oppositely disposed ends, said non-circular hole means being disposed adjacent one end of the handle means.

12. The hand tool of claim 11, said sleeve means being disposed at the other end of the handle means.

13. A hand tool tool bit drive sleeve comprising:
sleeve means comprising an elongated sleeve and a flange integral to said sleeve, said flange comprising means for rotatably connecting the sleeve means to a hand tool and further comprising a rotation axis, and said sleeve comprising a central axis, and wherein
the rotation axis is spaced from the central axis.

14. The sleeve of claim 13, said flange further comprising first stop means for holding said sleeve means in a first operable position with respect to the hand tool.

15. The sleeve of claim 13, said flange further comprising second stop means for holding said sleeve means in a second operable position with respect to the hand tool.

16. The sleeve of claim 15, said first and second stop means being disposed at 90°.

17. The sleeve of claim 13, wherein the sleeve comprises a cylinder, and wherein the rotation axis is spaced from the central axis about one-half the diameter of the cylinder.
